(19) United States
(12) Patent Application Publication
(10) Pub. No.: US 2008/0319720 A1
(43) Pub. Date: Dec. 25, 2008

(54) Connection fatigue index analysis for threaded connection

(76) Inventors: Sean Eugene Ellis, Houston, TX (US); Kang Lee, Houston, TX (US)

Correspondence Address: ARNOLD & KNOBLOCH, L.L.P., 2401 FOUNTAIN VIEW DRIVE, SUITE 630, HOUSTON, TX, 77057, US

(21) Appl. No.: 11/820,471

(22) Filed: Jun. 19, 2007

(51) Int. Cl. G06F 7/60

(52) U.S. Cl. 703/2

(57) ABSTRACT

A method for characterizing a threaded coupling such as between two tubular members is disclosed. In one embodiment, a threaded connection between a first tubular and a second tubular is considered, where the first tubular has a internally-threaded box structure and the second tubular has outer threads defining a pin structure. A mathematical model of the connection between the two tubulars is generated, and the mathematical model is permuted to reflect application of at least one flexing force to the joint. From the permuted model, a stress/strain distribution of the box and pin structures is derived. A connection fatigue index value is calculated based on the stress/strain distribution. In one embodiment, connection fatigue indices are computed for a variety of connection combinations, such that a user can compare the relative suitability of multiple box/pin combinations to select one that is deemed desirable for a particular use.

### FIELD OF THE INVENTION

The present invention relates generally to threaded connections between tubular segments, and more particularly to the threaded connections between individual segments of a drill string used in hydrocarbon exploration and production.

### BACKGROUND OF THE INVENTION

When designing drillstrings, the designer must specify both the type of connections and whether or not to ensure the use of components including certain stress relief features. It is known that the relative fatigue lives of drill string connections will vary for a number of different reasons, including, without limitation, the drill string dimensions, the thread form, the material properties of the pipe (e.g., box stiffness), connection taper, the presence or absence of certain fatigue relief features, the service environment, and most certainly others, as is well known in the art. It is also widely accepted that thread connection fatigue life is also dependent on a connection's service stress level, including cyclic stress level, at critical areas of the connection.

Because fatigue historically accounts for roughly 80% of all drill string mechanical failures and the cost of a failure can be quite substantial, it is in the interest of the oil and gas industry to utilize the most fatigue-resistant connections.

Finite element analysis (FEA) has been used in the prior art to model the stresses present in complex mechanical assemblies under multiple loads. Given the multiple loads involved (e.g., make-up torque, externally applied tension, bending, cyclical flexing, etc.), accurately analyzing the stress and strain distribution in a rotary-shouldered connection is generally regarded as a challenging matter, but one which is within the capabilities of persons of ordinary skill in the art using methodologies and other tools presently available.

Without question, accurate modeling of drill string connections can be achieved, as is shown by Ellis et al., “Use NC56 Connections on 8″ Drill Collars and Cut 1″ or ¾″ in Stress Relief Grooves on Rotated BHA Connections NC38 and Larger,” IADC/SPE Drilling Conference, IADC/SPE 87191, Mar. 2-4 2004 (“Ellis,” hereby incorporated by reference herein in its entirety). It is understood for the purposes of this disclosure that the teachings of Ellis are well-known and understood by a person of ordinary skill in the art.

In the prior art, absolute values (or estimates of such values) of stress and strain are often used as measures of how much better one design might be relative to another. When considering only overload or determining a factor of safety, this practice is acceptable in most instances. When evaluating differences in the fatigue performance of rotary-shouldered connections, however, looking only at the magnitude of stress or strain does not tell the whole story. That is, relatively small differences in the magnitude of stress and/or strain, for example, can have a much more pronounced impact on fatigue life.

Those of ordinary skill will appreciate that there are two primary failure modes for equipment: overload and fatigue. Using absolute values for stress and strain is the accepted practice for design when considering overload avoidance. In most cases, the bulk minimum material property that governs failure—the yield stress—is readily known and accepted. If the minimum yield strength and the area that is carrying the load are known, it is a straightforward matter to calculate how much load can be carried before the part begins to permanently deform. In particular, Failure Load=(Minimum Yield Stress)×(Area Carrying the Load).

Overload failures generally occur as a result of a singular application of load. A load of 49,000 lbf may be applied many times without any overload damage to a particular connection, and the load could be applied any number of times without connection failure. However, a single application of 50,000 lbf might permanently deform the connection structures and render the connection no longer useable.

Knowing the absolute stress and strain to predict an overload failure is desirable, because this stress and strain can directly be compared to a known limit or failure criteria. When considering fatigue, one must first establish that fatigue accumulates in a part over time as it is subjected to load (stress and strain) cycles and is irreversible. Two identical parts may last drastically different amounts of time because one is cyclically loaded at very high stress and strain levels and the other is cycled at relatively low stress and strain levels. Likewise, one part may be used in a corrosive environment and another in a benign environment under the same loading conditions but with drastically different fatigue performances.

It is widely known that equipment in the oilfield is generally rented and reused many times. When a part is first brought into service (a new part), there is no fatigue damage present or accumulated. Each time the part is used, some fatigue accumulates and the amount depends on the load conditions and operating environment. When a used part is selected, the user has no way of knowing how much of that part's fatigue life has been consumed or how much is remaining. The part may fail from fatigue at a load below the level under which it had previously been successfully operated.

Because prior service history of parts are generally unknown, parts may fail from fatigue at loads far below the threshold defined by overload. Parts may be operated in corrosive environments, and new cuts and gouges (stress concentrations) are introduced on the part as it is used. Consequently, it is impossible to predict in terms of absolute cycles how long a particular part will last, even knowing some of the relevant operational parameters and material properties. It is for this reason that designing to prevent fatigue is such a challenge as opposed to designing to prevent overload. For fatigue, there is much uncertainty, many unknown variables, and complex calculations. For overload, on the other hand, there is less uncertainty, with known variables and relatively simpler calculations.

### SUMMARY OF THE INVENTION

In view of the foregoing, the present invention is directed to a methodology for considering fatigue life rather than only stress and strain when comparing drill string design options. In accordance with one embodiment, operators will benefit from decreased costs associated with fishing and tool replacement, and drilling contractors and rental companies can benefit from increased tool life.

The approach in accordance with one aspect of the present invention, referred to herein as ‘relative fatigue design’ eliminates the consequence of much of the uncertainty and establishes constant values for variables. The calculations are complex, but are well within the capabilities of persons of ordinary skill using presently available computer systems. In so doing, various interchangeable tools or connections may be compared to one another for a particular application to see which option will perform the best given that each will be subjected to the same operating conditions.

For example, in one embodiment, if it is known that a section of 8 inch OD×2 13/16 inch ID drill collars are to be used in a bottom hole assembly (BHA), collars equipped with either NC56 or 6⅝ REG connections can be used. Assuming all else but the connection type equal, it is desirable to select a combination which minimizes the chances of fatigue failure. By using ‘relative fatigue design,’ the present invention in one embodiment enables the practitioner to determine that the NC56 connection is three times better than the 6⅝ REG connection (will last three times a long under the same operating conditions).

Exactly how long either connection will last may not be known, because absolute fatigue life cannot be known, as noted above. However, the present invention does enable a practitioner to determine that given a choice between the two or more options, demonstrably better performance can be achieved and the risk of fatigue failure can be significantly decreased by choosing the NC56 connection type. The same kind of analysis can be applied to other connection types, connection sizes, drill pipe weights and grades, heavy weight drill pipe, drilling trajectories, etc.

In accordance with one aspect of the invention, a methodology is provided for deriving a connection fatigue index (CFI) value for a tubular connection, based on a computer modeling of the connection including, at least, stress/strain distribution information for the connection.

In accordance with another aspect of the invention, the methodology takes into account a plurality of different connection parameters in order to generate a computer model.

In accordance with another aspect of the invention, the methodology further entails processing or manipulating the computer model of a connection to simulate the exertion of stresses and strains therein, including the application of make-up torque force and, in some embodiments, the application of cyclic bending loads.

A beneficial aspect of the invention is that connection fatigue index values for a variety of different connection types and sub-types can be compared, inasmuch as the CFI index values are derived in such a way as to ensure that they are mutually relative.

### BRIEF DESCRIPTION OF THE DRAWINGS

The foregoing and other features and aspects of the present invention will be best appreciated by reference to a detailed description of the specific embodiments of the invention, when read in conjunction with the accompanying drawings, wherein:

FIG. 1 is a side cross-sectional view of a tubular connection about which the present invention is concerned;

FIG. 2 is an enlarged area of the side cross-sectional view of FIG. 1 showing an illustrative wire mesh model being superimposed upon a portion thereof;

FIG. 2a is another side cross-sectional depiction of the enlarged area shown in FIG. 2; and

FIG. 3 is a reproduction of a full wire mesh model of a tubular connection.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such a development effort might be complex and time-consuming, but would nevertheless be a routine undertaking for those of ordinary skill in the relevant fields.

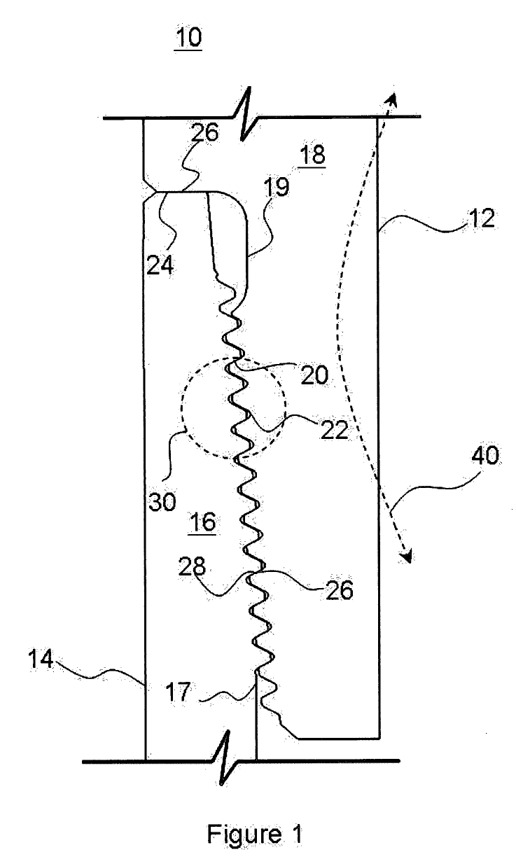

Referring to FIG. 1, there is shown a side cross-sectional view of a portion of a threaded connection 10 between a first tubular segment 12 and a second tubular segment 14. In particular, and as will be familiar to those of ordinary skill in the art, connection 10 comprises a “box” portion 16 and a “pin” portion 18. Box 16 could be considered to be the “female” half of the connection and pin 18 could be considered to be the “male” portion of the connection, as would be understood by those of ordinary skill. The threads of box 16 define a substantially spiraling box “crest” 20 while the threads of pin 18 define a substantially spiraling pin “root” 22. In accordance with conventional design, the threads of box 16 and pin 18 are tapered relative to the longitudinal axis of tubulars 12 and 14, facilitating insertion of pin 18 into box 16.

Connection 10 of FIG. 1 is of the common “rotary shouldered” type, inasmuch as box 16 has a substantially flat shoulder feature 24 that is compressed against a corresponding shoulder feature 26 of pin 18 when connection 10 is “made up” by rotation of tubular 12 relative to tubular 14, thereby tightening pin 18 within box 16. When connection 10 is fully made up, this being the condition shown in FIG. 1, respective shoulder features 24 and 26 are compressed against one another, forming a seal.

In accordance with common practice, connection 10 in FIG. 1 is provided with a stress relief feature in the form of a “boreback” groove 17 formed in the back of box 16, as shown in FIG. 1. Further, connection 10 is provided with another stress relief feature in the form of a groove 19 formed at the base of pin 18. Stress relief features such as those shown in FIG. 1 have been used for many years. The purpose of such a stress relief feature is to avoid the presence of unengaged threads that act as stress concentrators near pin shoulder 26 and box shoulder 24, as is well-known in the art.

The torque force applied to tubular 12 (and hence to pin 18) establishing the threaded connection 10 of pin 18 and box 16 is referred to as the make-up torque. As would be known to those of ordinary skill in the art, as the threaded connection 10 becomes fully engaged, the forces between threaded segment 18 and box segment 16 will be exerted principally between the pin thread load flank 27 and the box load flank 28. In the aggregate, the make-up torque tends to exert a stretching force on the threads of pin 18 and a compressive force on the threads of box 16. These forces result in the compression of the respective shoulder features 24 and 26 against one another.

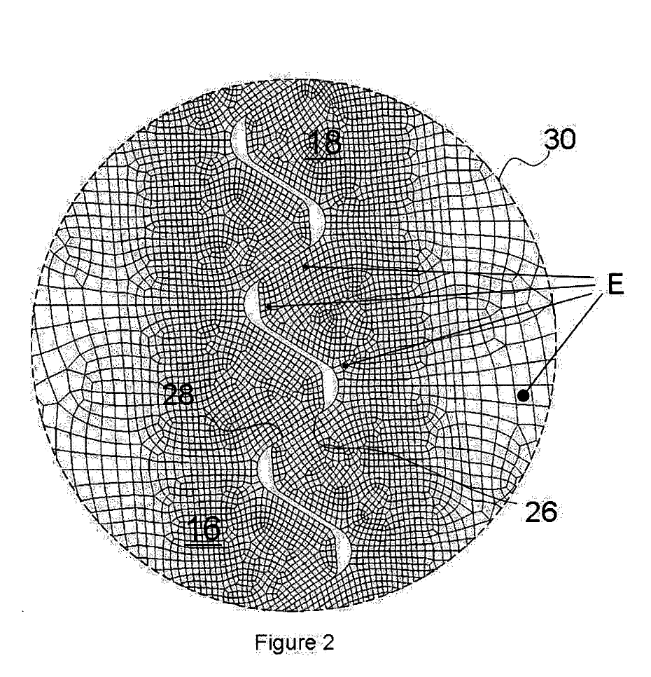

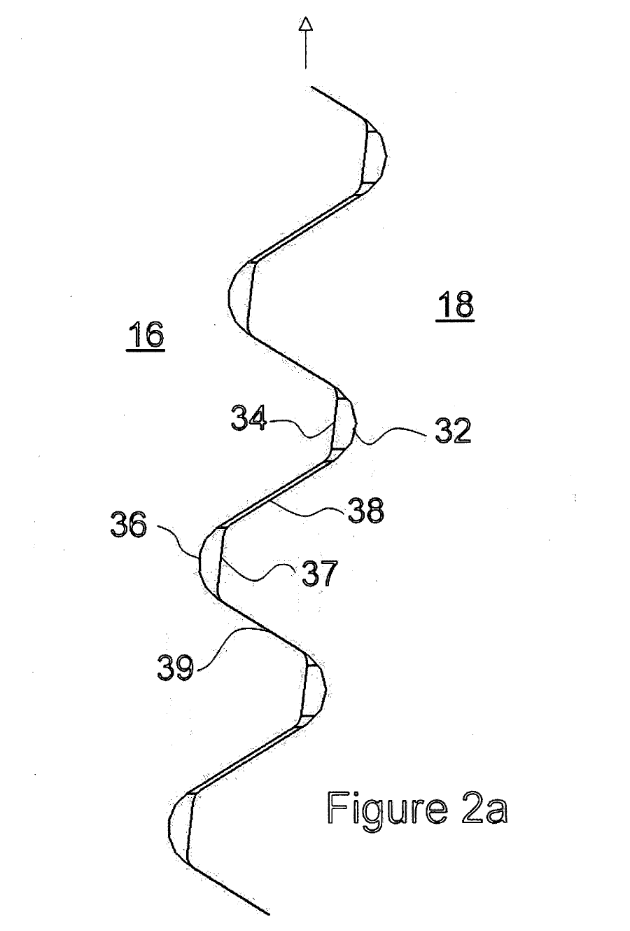

FIG. 2 is an enlarged cross-sectional view of the portion of connection 10 enclosed by dashed circle 30 in FIG. 1. As previously noted, and in accordance with one embodiment of the invention, the fatigue life of a given rotary shouldered connection such as connection 10 in FIG. 1 may be quantified through analysis of the stress and strain distributions in the box 16 and pin 18.

FIG. 2a is another enlarged cross-sectional view of the portion of connection 10 within dashed circle 30 in FIG. 1. Reference numeral 32 identifies what is referred to as a pin root, while reference numeral 34 identifies a corresponding box crest. Similarly, reference numeral 36 identifies a box root, while reference numeral 37 identifies a corresponding pin crest. The lower face 38 of the pin thread is referred to ask the stabbing flank of the connection, while the lower face 39 of the box thread is referred to as the load flank of the connection.

The first step in analyzing the stress and strain distribution in a given connection is to generate a computer model of the connection. In the presently preferred embodiment, and as would be familiar to those of ordinary skill in the art, the computer model may consist of a wire “mesh” composed of a plurality of discrete elements E. In FIG. 2, an illustrative example of a partial wire mesh model of pin 18 is shown, with representative elements of the mesh being denoted with an E, and the vertices (nodes) defining the elements. One or more stress and/or strain values is specified for each element E of the mesh, providing the stress/strain distribution.

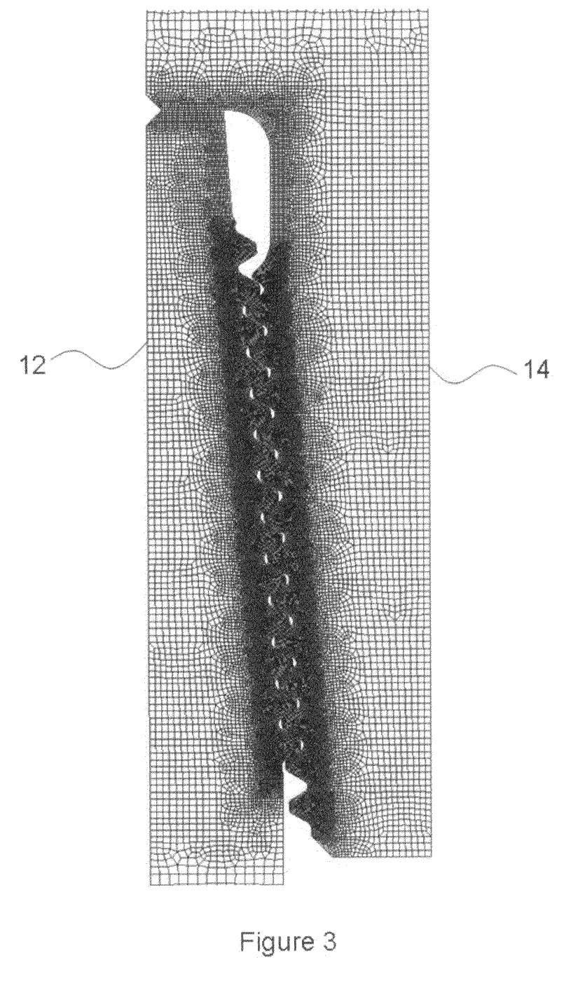

As would be apparent to those of ordinary skill, in order to accurately describe the geometry and shape of a structure such as connection 10, each of the elements E must be small enough to closely approximate the contours present in the specific areas of interest. In the case of rotary-shouldered connection 10 from FIG. 1, the threads and stress relief features (if any) are of primary interest. Therefore, as would be apparent to those of ordinary skill, the mesh in these regions is correspondingly dense. Regions spaced away from these critical areas may have a more coarse mesh. An example of a complete wire mesh model of connection 10 is shown in FIG. 3. The aforementioned Ellis reference includes a more detailed description of the process of computer modeling of a connection, as this process is presently known and understood by those of ordinary skill in the art.

Absolute values of stress and strain are often used as measures of how much better one connection design is relative to another. There are numerous parameters of connections that can be varied in an effort to maximize overall desirable properties of the connection, including, without limitation, thread root radius, thread taper, pitch diameter, stress relief groove width, and so on. It is known in the art that the stress/strain distribution throughout a connection can be presented to a user by various means, for example, by a graphical representation wherein gradations of color are used to indicate gradations in the stress/strain distribution.

When considering only overload or determining a factor of safety, utilization of absolute values of stress and strain may be acceptable. On the other hand, when evaluating differences in the fatigue performance of rotary-shouldered connections, this may not be sufficient. Accordingly, and in accordance with one aspect of the invention, an approximation of fatigue life is preferably derived in order to better understand the impact that both stress and strain have on the performance of a connection.

For example, it has been shown (in, e.g., Ellis) that an approximately 20% change in stress magnitude equates to an approximately 110% difference in cycles-to-failure. (See, Ellis, FIG. 4). In sum, Ellis shows that relatively small differences in stress and strain can have a dramatic effect upon fatigue life. Therefore, fatigue life, measured in cycles to failure, is a preferred means of determining an optimal connection design versus other available designs.

For the purposes of the present invention, it is desirable to account for plastic strain, stress, and fatigue in a given connection. In one embodiment, this is accomplished using the Morrow Strain-Life Model, namely:

$${ɛ}_{a} = \frac{{σ}_{f}^{′} - {σ}_{m}}{E} {( 2 {N}_{f} )}^{b} + ( {ɛ}_{f}^{′} - {ɛ}_{inp} ) {( 2 {N}_{f} )}^{c}$$

where

Eₐ=strain amplitude

σ′_{f}=material fatigue constant determined experimentally

σ′_{f}=mean stress (psi), when σₘ>σ_{ys}, set σₘ=σ_{ys}

E=Young's Modulus

N_{f}=number of cycles to failure

b=material fatigue constant determined experimentally

ε′_{f}=material fatigue constant determined experimentally

εₘₚ=mean plastic strain, when σₘ≦σ_{ys}, set εₘₚ=0

c=material fatigue constant determined experimentally

In accordance with one embodiment of the invention, a quantification of the fatigue life for a given connection (a Connection Fatigue Index, or “CFI”) can be used to determine which connection type(s) will perform best relative to one another. Connections may be compared according to different parameter values for such parameters as thread type, connection inner and outer diameter, dogleg severity (imposed curvature), MUT, and others, as well as considerations such as whether certain types of strain relief features are employed. In one embodiment, mud corrosion effects may also be taken into account.

The process of deriving a CFI for a given connection in accordance with the presently disclosed embodiment begins with generation of a computer finite element analysis (FEA) model of the connection, as described above. Next, the model is analyzed by virtual application of a make-up torque to the modeled connection. That is, the mathematical model is processed or mathematically manipulated to simulate the exertion of a make-up torque force on the connection being modeled. For example, a make-up torque corresponding to the standards promulgated by the American Petroleum Institute (API) and widely used in the industry, may be virtually applied to the model. Application of make-up torque will result in changes in the stress/strain distribution, and these changes can be quantified using conventional finite element analysis techniques.

Next, and in accordance with another preferable aspect of the invention, the connection model is processed or manipulated to simulate subjecting the connection being modeled to a range of cyclic bending loads, sufficient to reflect all popular dogleg severity standards in the industry. The bending load is represented by dashed arrow 40 in FIG. 1. The analysis process in accordance with the invention works by evaluating the connection model under the applied loads. The connection elastic-plastic cyclic stress/strain response, and the cyclic stress/strain mean and amplitude values can then be measured at critical areas of connection 10. By applying these measured cyclic stress/strain values into the Morrow Strain-Life Model described above, the fatigue life can be determined for the applied loads.

In one embodiment, CFI derivation utilizes connection configuration parameters (thread type, outer diameter, inner diameter, stress relief groove(s) configuration(s), and so on) as variables, while maintaining material properties and service environment factors as constants. After application of the Morrow Strain-Life Model, a CFI value is obtained by dividing the resulting fatigue life values by a constant factor. The CFI value provides an approach for comparing the fatigue resistance ability between dissimilar connections and for selecting or designing connections to maintain a longer fatigue life.

In one embodiment, once the FEA analysis has been completed for a specific connection, the box and pin fatigue lives are calculated independently. These two values are then compared, and the lower of the two values (i.e., the weakest link) is chosen as the fatigue life for the connection as a whole, i.e., including both the pin and the box. This value is then converted into a CFI value, which can then be used to compare the unique connection with the CFI values of other unique connections on a relative basis.

Those of ordinary skill in the art will appreciate that there are a wide variety of different connector types commonly used in the industry. Connections can differ in a number of ways, including size, type, material properties, to name but a few. Accordingly, and in accordance with another aspect of the invention, it is contemplated that a compilation or catalog of datasets can be generated containing data (CFI values) for many different possible combinations of connector types, taking into account normal loading conditions, make-up torque forces, bending loads, and so on.

In one embodiment, the compilation of datasets would include multiple CFI values for a given type of connection, each of these CFI values corresponding to a variable sub-type of that connection. Thus, for example, the compilation of data might include a dataset including CFI values for NC56 connections of varying diameters, while another dataset includes CFI values for a 6-⅝ REG API connections of varying diameters.

Likewise, the compilation of data may include datasets for a particular connection type and for a plurality of different stress relief features of that connection type.

In general, it is contemplated that a compilation of data in accordance with the present invention will include a plurality of datasets, each dataset corresponding to a particular type of connection, and for a plurality of sub-types of that type of connection. Subtypes might include any variable parameter or feature of the connection, e.g., thread root radius, thread taper, pitch diameter, inner- and outer-diameters, and so on. In accordance with an important feature of the invention, the datasets are derived such that the CFI data for a particular connection (type and/or subtype) can be compared with the CFI data for an entirely different connection type and or subtype, in order to obtain a quantified measure of the normalized fatigue lives of these different connections.

This compilation of data thereby provides an operator with a means for assessing the suitability of particular connections in particular circumstances on a relative basis, rather than merely on an absolute basis. This provides an advantage not realized in the prior art, in which no common frame of reference is available for the wide range of possible unique connections that can be made.

Although specific embodiments of the invention has been described herein in some detail, it is to be understood that this has been done solely for the purposes of illustrating various features and aspects of the invention, and is not intended to be limiting with respect to the scope of the invention, as defined in the claims. It is contemplated and to be understood that various substitutions, alterations, and/or modifications, including such implementation variants and options as may have been specifically noted or suggested herein, may be made to the disclosed embodiment of the invention without departing from the spirit or scope of the invention.

What is claimed is:

1. A method of characterizing a connection between first and second elongate tubular segments, said first elongate tubular segment having a box structure at one end thereof and said second tubular segment having a pin structure at one end thereof, said pin structure and said box structure having complementary threaded features enabling said box structure and said pin structure to engage one another, wherein said method of characterizing comprises:
generating a mathematical model of said connection;
subjecting said mathematical model of said connection to at least one force;
deriving a stress/strain distribution for said connection resulting from application of said force; and
computing, from said stress/strain distribution, a connection fatigue index value for said connection.

2. A method in accordance with claim 1, wherein said step of generating a model of said connection comprises generating a wire mesh model of said connection.

3. A method in accordance with claim 2, wherein said step of computing a connection fatigue index value comprises applying said stress strain distribution to a predetermined formula.

4. A method in accordance with claim 3, wherein said predetermined formula is the Morrow Strain Life model.

5. A method in accordance with claim 1, wherein said step of subjecting said model to at least one force comprises subjecting said model to a predetermined make-up torque.

6. A method in accordance with claim 5, wherein said step of subjecting said model to at least one force further comprises subjecting said model to at least one bending load.

7. A method in accordance with claim 1, wherein said step of generating a mathematical model of said connection comprises accounting for a plurality of parameters which vary from one connection type to another.

8. A method in accordance with claim 1, wherein said step of generating a mathematical model of said connection comprises accounting for inner and outer diameters of said first and second tubular members.

9. A method in accordance with claim 6, wherein said first and second tubular members comprises segments of a drill string.

10. A compilation of data, comprising a plurality of data sets, each data set consisting of a plurality of connection fatigue index values computed for a plurality of connection types.

11. A compilation of data in accordance with claim 10, wherein said compilation of data enables a user to compare a connection fatigue value of a first connection type with a connection fatigue value of a second connection type to assess the relative estimated performance of said first and second connection types.

12. A compilation of data in accordance with claim 11, wherein a connection fatigue value is derived for each of a plurality of connection types based upon a plurality of variable parameters of said each connection type.

14. A compilation of data in accordance with claim 10, wherein each said connection fatigue index value is derived from a mathematical model of a particular connection type.

15. A compilation of data in accordance with claim 11, wherein said mathematical model comprises a wire mesh model suitable for finite element analysis to determine a stress and strain distribution in said connection.

16. A compilation of data in accordance with claim 15, wherein said mathematical model is subjected to at least one force causing a change in said stress and strain distribution in said connection.

17. A compilation of data in accordance with claim 16, wherein said at least one force includes a make-up torque force.

18. A compilation of data in accordance with claim 17, wherein said at least one force includes a bending load force.

19. A compilation of data in accordance with claim 10, wherein said connection fatigue index corresponds to a number of cycles to failure of said connection.
